(19) United States
(12) Patent Application Publication
(10) Pub. No.: US 2021/0326777 A1
(43) Pub. Date: Oct. 21, 2021

(54) SYSTEM AND METHOD FOR ENABLING PASSENGER TRANSPORTATION ON COMMERCIAL VEHICLES

(71) Applicant: Hiike Inc., Oklahoma City, OK (US)

(72) Inventor: Cole Stevens, Blanchard, OK (US)

(21) Appl. No.: 17/235,589

(22) Filed: Apr. 20, 2021

Related U.S. Application Data
(60) Provisional application No. 63/013,171, filed on Apr. 21, 2020.

(51) Int. Cl. G06Q 10/02; G06Q 10/06; G06Q 50/30; H04L 9/32

(52) U.S. Cl. CPC G06Q 10/02; H04L 9/3247; G06Q 50/30; G06Q 10/06315

(57) ABSTRACT

A system and process for facilitating passenger travel, including receiving trip itineraries from a plurality of driver devices; receiving a rideshare request from at least one passenger device; matching the rideshare request with at least one trip itinerary; generating a passenger manifest identifying passenger name, selected driver name, pick-up location, drop-off location, a date of travel, a motor carrier name, and motor carrier number, and a signature of an authority owner; booking a ridesharing trip including the passenger with the selected driver; providing the driver device with the rideshare request based on the driver selection; providing a rideshare request confirmation to the passenger device; and storing the passenger manifest on the non-transitory computer readable medium.

### INCORPORATION BY REFERENCE

The present patent application claims priority to the provisional patent application identified by U.S. Ser. No. 63/013,171, filed on Apr. 21, 2020, the entire content of which is hereby incorporated herein by reference.

### BACKGROUND

Ridesharing is a method of travel where those seeking ground transportation rely on private drivers to provide transportation through the use of rideshare services.

Such rideshare services allows those seeking ground transportation to request transportation services from a particular pick-up point location to a specified drop-off point location, and allows private drivers to accept such requests based on their schedule and willingness to travel the requested route. However, private drivers are often unwilling to accept requests which require the driver to transport passengers very long distances. Traditionally, a person seeking ground transportation for long distances rely on public transportation and commercial passenger carrier services, such as commercial busses. However, those relying on public transportation and commercial passenger carrier services cannot schedule such transportation services at their own convenience, but rather must conform to posted schedules.

Commercial trucking services dispatch drivers to travel great distances on a regular basis to deliver goods across the country. These truck drivers often travel alone and make frequent stops at public rest areas. The operation of commercial trucks is heavily regulated by the government. Commercial trucking companies generally utilize a fleet of Class 8 heavy trucks, such as semi-trailer trucks, to haul freight. But before a commercial trucking company can haul freight, it must first obtain a motor carrier authority and a motor carrier number which will then be associated with its Class 8 trucks. Moreover, the drivers that operate Class 8 trucks must receive special licensing to operate such trucks. Federal regulation further prohibits the transportation of unauthorized persons on any commercial motor vehicle, unless specifically authorized in writing to do so by the trucking authority operating the commercial motor vehicle.

Therefore, a need exists for a system and method of connecting those seeking ground transportation and drivers of commercial motor vehicles to provide transportation services in a manner that does not contravene federal regulation. It is to such a system and method that the presently disclosed inventive concepts are directed.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of hardware forming an exemplary embodiment of a system for connecting a passenger and an available driver constructed in accordance with the present disclosure.

FIG. 2 is a diagrammatic view of an exemplary user device for use in the system for connecting a passenger and an available driver illustrated in FIG. 1.

FIG. 3 is a diagrammatic view of an exemplary embodiment of a host system for use in the system for connecting a passenger and an available driver illustrated in FIG. 1.

FIG. 4 is a flow diagram illustrating operation of an exemplary method of connecting a passenger and an available driver in accordance with the present disclosure.

FIG. 5 is an illustration of an exemplary passenger home screen in accordance with some embodiments of the present disclosure.

FIG. 6 is an illustration of an exemplary passenger rideshare location input screen in accordance with some embodiments of the present disclosure.

FIG. 7 is an illustration of an exemplary passenger drop-off point selection screen in accordance with some embodiments of the present disclosure.

FIG. 8 is an illustration of an exemplary driver selection screen in accordance with some embodiments of the present disclosure.

FIG. 9 is an illustration of an exemplary driver profile screen in accordance with some embodiments of the present disclosure.

FIG. 10 is an illustration of an exemplary passenger scheduling selection screen in accordance with some embodiments of the present disclosure.

FIG. 11 is an illustration of an exemplary passenger trip booked screen in accordance with some embodiments of the present disclosure.

FIG. 12 is an illustration of an exemplary progress tracking screen in accordance with some embodiments of the present disclosure.

FIG. 13 is an illustration of an exemplary passenger authorization manifest in accordance with some embodiments of the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

The term “field” means a location for computer data input and/or output of text, symbol(s) and/or value(s) having at least one corresponding associated place in computer memory.

The term “location data” means information which uniquely identifies geographic position. This may include latitude and longitude coordinates, a street address and/or otherwise.

The term “latitude and longitude coordinates” means numeric coordinates for a location on the planet corresponding to latitude (east, west) and longitude (north, south).

The term “region” means an area on earth that is identified by an identifier, such as a town, city, county, zip code or the like.

The term “user-acceptance” means an affirmative step or series of steps or computer input, undertaken by user to make a selection.

The term “visual marker” is a shape, pointer, label, icon, avatar or other indicator which is movable or displayable on a computer screen and which may be visually differentiated from other objects on the computer screen.

The term “selectable indicator” is a graphical control element associated with one or more predetermined instruction that may be selected and thus provides the user a way to execute the one or more predetermined instruction. Exemplary selection elements include, but are not limited to a button, a checkbox, a banner, or the like.

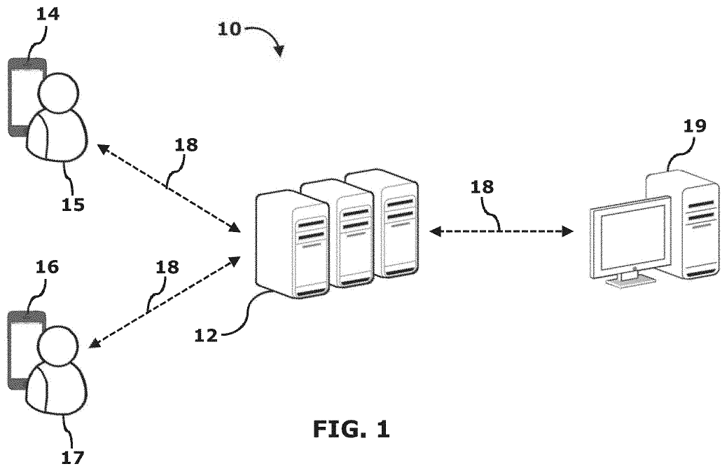

Referring now to the Figures, and in particular to FIG. 1, shown therein is a diagrammatic view of hardware forming an exemplary embodiment of a system 10 for connecting a passenger and an available driver in real-time constructed in accordance with the present disclosure.

The system 10 is provided with at least one host system 12 (hereinafter “host system 12”), a plurality of passenger devices 14 (hereinafter “passenger device 14”), a plurality of driver devices 16 (hereinafter “driver device 16”), and a network 18. In some embodiments, the system 10 may include at least one external system 19 (hereinafter “external system 19”) for use by a truck operating authority to add, delete, or modify driver information and privileges, manage driver itineraries, and manage passenger authorization manifests. The system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors as depicted in FIG. 1, for example.

The host system 12 of the system 10 may include a single processor or multiple processors working together or independently to perform a task. In some embodiments, the host system 12 may be partially or completely network-based or cloud based. The host system 12 may or may not be located in single physical location. Additionally, multiple host systems 12 may or may not necessarily be located in a single physical location.

In some embodiments, the system 10 may be distributed, and include at least one host system 12 communicating with one or more passenger device 14 via the network 18. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 18 may be the Internet and/or other network. For example, if the network 18 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet-based application, a mobile web interface, and/or the like.

The network 18 may be almost any type of network. For example, in some embodiments, the network 18 may be a version of an Internet network (e.g., exist in a TCP/IP-based network). It is conceivable that in the near future, embodiments within the present disclosure may use more advanced networking technologies.

In some embodiments, the external system 19 may optionally communicate with the host system 12. For example, in one embodiment of the system 10, the external system 19 may supply data transmissions via the network 18 to the host system 12 regarding real-time or substantially real-time events (e.g., driver itinerary updates and/or driver rideshare privilege updates). Data transmission may be through any type of communication including, but not limited to, speech, visuals, signals, textual, and/or the like. Events may include, for example, data transmissions regarding driver itinerary updates, or, for example, data transmission regarding a driver's authority to accept a rideshare request, initiated via the external system 19. It should be noted that the external system 19 may be the same type and construction as the driver device 16.

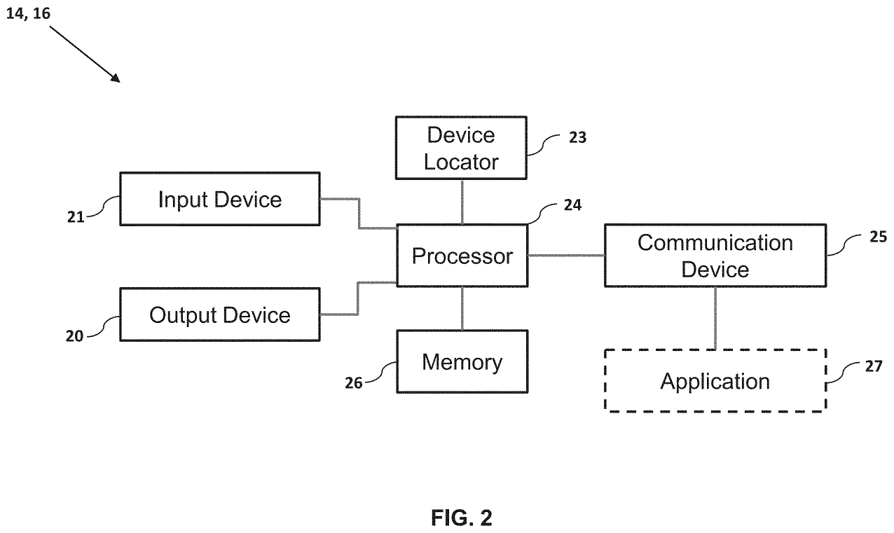

As described herein, the passenger device 14 and the driver device 16 may be implemented as similar devices. Therefore, in the interest of brevity, the elements of the passenger device 14 and the driver device 16 will be described herein using the same numerical designations. As shown in FIG. 2, the passenger device 14 and the driver device 16 of the system 10 may include, but are not limited to implementation as a personal computer, a cellular telephone, a smart phone, a tablet, a laptop computer, a desktop computer, a network-capable handheld device, a server, a wearable network-capable device, and/or the like.

In some embodiments, the passenger device 14 and the driver device 16 may include one or more output devices 20 (hereinafter “output device 20”), one or more input devices 21 (hereinafter “input device 21”), a device locator 23, one or more processors 24 (hereinafter “processor 24”), one or more communication devices 25 (hereinafter “communication device 25”) capable of interfacing with the network 18, one or more non-transitory memory 26 (hereinafter “memory 26”) storing processor executable code and/or software application(s), for example including, a web browser capable of accessing a website and/or an application 27 capable of communicating information and/or data over a wireless or wired network (e.g., network 18), and/or the like.

The memory 26 may also store the application 27 that, when executed by the processor 24 causes the passenger device 14 to automatically and without user intervention collect predefined pick-up location information based on the user's current location as determined by the device locator 23 to allow the user to quickly and accurately select a pick-up point location and track the rideshare progress as the passenger travels to the drop-off point location. The pick-up location may be identified with location data.

Embodiments of the system 10 may also be modified to use any future developed devices capable of communicating with the host system 12 via the network 18 as the customer device 14 and/or the driver device 16.

The device locator 23 may be configured to determine the position of the passenger device 14 and/or the driver device 16. For example, implementations of the device locator 23 may include, but are not limited to, a Global Positioning System (GPS) chip, software based device triangulation methods, network-based location methods such as cell tower triangulation or trilateration, the use of known-location wireless local area network (WLAN) access points using the practice known as “wardriving”, a hybrid positioning system combining two or more of the technologies listed above, or any future developed system or method of locating a device such as the passenger device 14 and/or the driver device 16.

The input device 21 may be configured to receive information input from the user and/or processor 24, and transmitting such information to other components of the passenger device 14, the driver device 16, and/or the network 18. The input device 21 may include, but are not limited to, implementation as a keyboard, touchscreen, mouse, trackball, microphone, slide-out keyboard, flip-out keyboard, cell phone, PDA, remote control, fax machine, wearable communication device, network interface, combinations thereof, and/or the like, for example.

The output device 20 may be capable of outputting information in a form perceivable by the user and/or processor 24. For example, implementations of the output device 20 may include, but are not limited to, a computer monitor, a screen, a touchscreen, a speaker, a website, a television set, a smart phone, a PDA, a cell phone, a printer, a laptop computer, combinations thereof, and the like, for example. It is to be understood that in some exemplary embodiments, the input device 21 and the output device 20 may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

The host system 12 may be configured to interface and/or communicate with the passenger device 14, the driver device 16, and the external system 19 via the network 18. For example, the host system 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems 12 directly and/or via the network 18, such as by exchanging signals (e.g., analog, digital, optical, and/or the like) via one or more ports.

The network 18 may permit bi-directional communication of information and/or data between the host system 12, the passenger device 14, the driver device 16, and/or the external system 19. The network 18 may interface with the host system 12, the passenger device 14, the driver device 16, and/or the external system 19 in a variety of ways. For example, in some embodiments, the network 18 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 18 may be implemented as the World Wide Web (or Internet), a local area network (LAN), a wide area network (WAN), a metropolitan network, a 4G network, a satellite network, a radio network, an optical network, a cable network, a public switch telephone network, an Ethernet network, combinations thereof, and the like, for example. Additionally, the network 18 may use a variety of network protocols to permit bi-directional interface and/or communication of data and/or information between the host system 12, the passenger device 14, the driver device 16, and/or the external system 19.

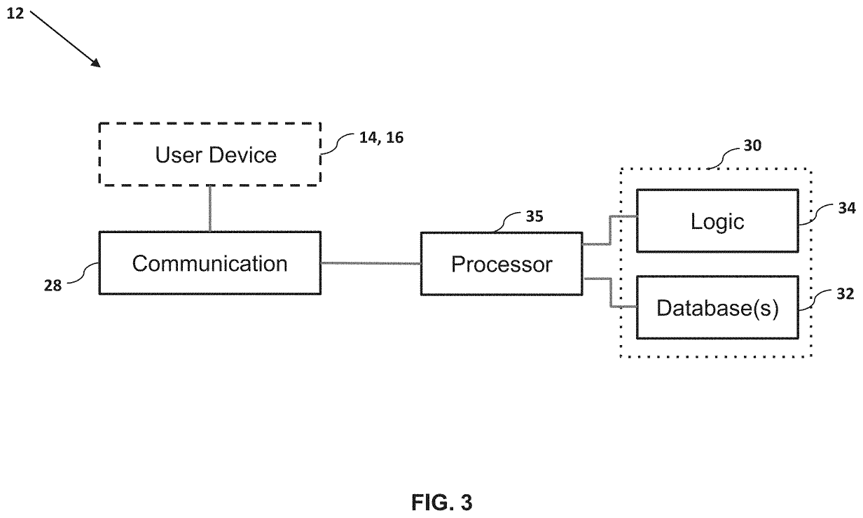

Referring now to FIG. 3, shown therein is a diagrammatic view of an exemplary embodiment of the host system 12. In the illustrated embodiment, the host system 12 is provided with one or more communication devices 28 (hereinafter “communication device 28”), one or more non-transitory computer readable medium 30 (hereinafter “storage 30”), one or more databases 32 (hereinafter “database 32”), program logic 34, and one or more processors 35 (hereinafter “processor 35”). Data requests from the application 27 of the passenger device 14, or the driver device 16 via the communication device 28 are processed by the program logic 34, organized by the database 32 functionality and stored permanently by the storage 30. The program logic 34 and the database 32 are stored on the storage 30, which may be one or more non-transitory computer readable medium accessible by the processor 35 of the host system 12. It should be noted that as used herein, program logic 34 is another term for instructions which can be executed by the processor 24 or the processor 35. The database 32 can be a relational database or a non-relational database. Examples of such databases comprise, DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 32 can be centralized or distributed across multiple systems.

In some embodiments, the host system 12 may comprise one or more processor 35 working together, or independently to, execute processor executable code stored on the storage 30. Additionally, each host system 12 may include at least one communication device 28 configured to interface with application 27 of the passenger device 14, or the driver device 16 via network 18. Each element of the host system 12 may be partially or completely network-based or cloud-based, and may or may not be located in a single physical location.

The processor 35 may be implemented as a single processor or multiple processors working together, or independently, to execute the program logic 34 as described herein. It is to be understood, that in certain embodiments using more than one processor 35, the processors 35 may be located remotely from one another, located in the same location, or comprising a unitary multi-core processor. The processor 35 may be capable of reading and/or executing processor executable code and/or capable of creating, manipulating, retrieving, altering, and/or storing data structures into the memory 36.

Exemplary embodiments of the processor 35 may be include, but are not limited to, a digital signal processor (DSP), a central processing unit (CPU), a field programmable gate array (FPGA), a microprocessor, a multi-core processor, combinations, thereof, and/or the like, for example. The processor 35 may be capable of communicating with the storage 30 via a path (e.g., data bus). The processor 35 may be capable of communicating with the communication device 28 via a path, such as a data bus.

The processor 35 may be further configured to interface and/or communicate with the passenger device 14, the driver device 16, and/or the external system 19 via the network 18. For example, the processor 35 may be configured to communicate via the network 18 by exchanging signals (e.g., analog, digital, optical, and/or the like) via one or more ports (e.g., physical or virtual ports) using a network protocol to provide updated information to the application 27 executed on the passenger device 14 or the driver device 16 such as, for instance, real-time location updates for a passenger travelling to a drop-off point location as will be discussed in further detail herein.

The storage 30 may store processor executable code and may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like.

In some embodiments, the storage 30 may be located in the same physical location as the host system 12, and/or the storage 30 may be located remotely from the host system 12. For example, the memory 36 may be located remotely from the host system 12 and communicate with the processor 35 via the network 18. Additionally, when more than one storage 30 is used, a first storage 30 may be located in the same physical location as the processor 35, and additional storage 30 may be located in a location physically remote from the processor 35. Additionally, the memory 36 may be implemented as a “cloud” non-transitory computer readable storage memory (i.e., one or more storage 30 may be partially or completely based on or accessed using the network 18).

The communication device 28 of the host system 12 may transmit data to the processor 35 and may be similar to the communication device 25 of the passenger device 14 and the driver device 16. The communication device 28 may be located in the same physical location as the processor 35.

The storage 30 may store processor executable code and/or information comprising the database 32 and program logic 34. In some embodiments, the processor executable code may be stored as a data structure, such as the database 32 and/or data table, for example, or in non-data structure format such as in a non-compiled text file.

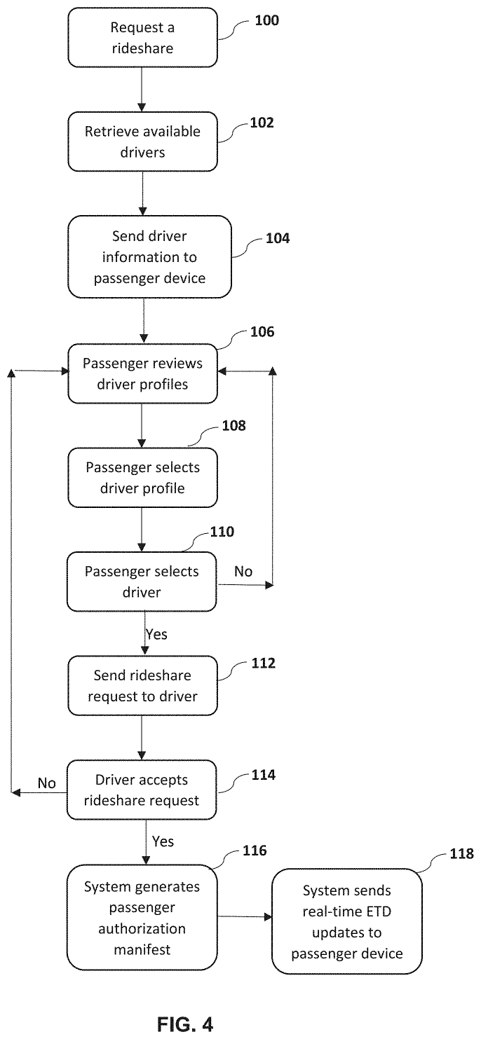

FIG. 4 is a flow diagram illustrating operation of the application 27 for a user who is a passenger. At a step 100 the application 27 directs the processor 24 to transmit a rideshare request to the host system 12 via the communication device 25 and the network 18. The rideshare request from the passenger device 14 may be received at the host system 12. The request may include passenger profile data that identifies the passenger requesting the rideshare (i.e., passenger identification data), his or her location (i.e., passenger location data such as latitude/longitude), pick-up point location data, drop-off point location data, and information about the passenger, including passenger preferences (i.e., passenger preference data).

The passenger identification data may be passenger information that is associated with the passenger that is logged into the application 27 on the passenger device 14. The passenger data may be stored locally on the passenger device 14 or may be stored on the host system 12 in the database 32, for instance, and accessed over the network 18. The passenger profile data may include, for instance, the name of the passenger, a phone number, an email address, or other personally identifiable information to allow a driver to contact the passenger after the rideshare request has been received.

The passenger location data may be captured in real-time by the device locator 23 of the passenger device 14 upon the initiation of a rideshare request with the input device 21. The application 27 may be programmed to access the location data being generated by the device locator 23 only when authorized. For instance, the application 27 may be authorized to access the location data 1) whenever the application 27 is open, 2) when the user selects an option with the input device 21 that requires the application 27 to access the location data, or 3) the application 27 may be programmed to require user authorization from the input device 21 every time location data is required. It should be noted that the application 27 may be programmed to allow access to the location data in other schemes so long as the user's location data is only transmitted upon authorization by the user.

The pick-up location data may be obtained in one embodiment of the application 27 by sending the location data generated by the device locator 23 to the host system 12 via the network 18. In this embodiment, the host system 12 is programmed to match the location data with an authorized pick-up location which may be stored, for instance in the database 32 on the host system 12. In some embodiments the list of pick-up locations may include only pre-authorized locations, e.g., truck stops or other locations easily accessible from a highway by a class 8 vehicle. The pick-up locations may be identified with location data. An exemplary highway includes an interstate highway, state highway or the like. Once the host system 12 has located a pick-up location matching the location data, the host system 12 may be programmed to send the pick-up location data to the passenger device 14 via the network 18 and the communication device 25. In such an embodiment, the application 27 may be programmed to show the pick-up location data to the passenger in such a way that the user may verify that the pick-up location data is for the location they would like to use as the pick-up location. For example, a pin representing the location of the pick-up location on a map can be provided and displayed on the output device 20.

In an instance where the host system 12 is unable to match pick-up location data with the passenger location data, the application 27 may be programmed to allow the passenger to manually enter information about their preferred pick-up location using the input device 21 such as by entering a physical address, cross-streets, a city, a zip code, or other information which will allow the host system 12 to locate the pick-up location data.

The drop-off location data may be obtained in this embodiment of the application 27 by allowing a passenger to manually enter information about the drop-off location using the input device 21 to send to the host system 12 via the network 18. In this embodiment the passenger may enter, for example, a physical address, cross-streets, a city, a zip code, or other information which will allow the host system 12 to locate the drop-off location data. In this embodiment, the host system 12 is programmed to match the drop-off location data with an authorized drop-off location, e.g., truck stops, which may be stored, for instance in the database 32 on the host system 12. In some embodiments, the list of drop-off locations may include only pre-authorized locations, such as truck stops which are easily accessible by a class 8 vehicle from a highway. Pre-authorization may include authorization from the owner/operator of the host system 12, and the owner/operator of the location prior to such location being listed as an authorized pick up or drop-off location. In other embodiments, the list of drop-off locations also includes the list of pick-up locations. Once the host system 12 has located a drop-off location matching the inputted location, the host system 12 may be programmed to send the drop-off location to the passenger device 14 via the network 18 and the communication device 25. In such an embodiment, the application 27 may be programmed to show the drop-off location data to the passenger in such a way that the passenger may verify the drop-off location data is the location that the passenger would like to use as their drop-off location. For example, a pin representing the location of the drop-off location on a map can be provided and displayed on the output device 20.

The passenger preference data may be obtained in this embodiment of the application 27 by allowing a passenger to manually select preference options from a predefined list of preferences using the input device 21 to send to the host system 12 via the network 18. In this embodiment the passenger may select preferences regarding his or her ideal driver, for example, whether the driver would listen to music, how much conversation a passenger would like to have with a driver, whether a driver takes frequent bathroom breaks, the temperature the driver maintains in the truck, whether the driver smokes inside or outside of the truck, or whether the driver travels with a pet. In this embodiment, the host system 12 is programmed to match the passenger preference data with driver preference data, similarly obtained from the driver, which may be stored, for instance in the database 32 on the host system 12. In some embodiments, the host system 12 will compare the passenger preference data with driver preference data to calculate a match score that correlates how many passenger preferences are met by a particular driver. In such an embodiment, the application 27 may be programmed to show the match score to the passenger in such a way that the passenger may verify whether the passenger would like to travel with the driver. For example, a percentage score representing the match score can be provided and displayed on the output device 20.

At a step 102, the host system 12 may retrieve a set of potential drivers, such as from the database 32 stored on the memory 36 of the host system 12. Potential drivers may be those who have logged into the application 27 with the input device 21 and are scheduled to travel to the requested locations, for instance, by sharing their driver itinerary in the application 27. A driver itinerary may include a load pick-up location, a pick-up region a drop-off region, and a final destination. The driver itinerary may include an expected time of arrival at the pick-up region and/or the drop off region. The load pick-up location may be a city, zip code or the like identifying where the driver will begin driving a route to the final destination. The pick-up region can be a city along the route. The drop-off region can also be a city along the route. The host system 12 may also retrieve a driver's planned route from external system 19. In another embodiment, the application 27 may be programmed to determine the availability of a driver after determining not only whether a driver's itinerary matches a rideshare request, but also by confirming a driver's authority to accept a rideshare request by retrieving and analyzing a driver's privileges from external system 19.

To keep the itinerary of the drivers current, the host system 12 may be programmed to obtain current location, current velocity, etc. of the driver to determine whether the driver is operating in accordance with the driver's itinerary. For example, the host system 12 may ping the driver device 16 of each driver on a predetermined or random schedule to determine the current location of the driver device 16 once the driver has logged into the application 27 for the day, for instance. In other embodiments, the application 27 on the driver device 16 may be programmed to periodically or randomly report location data to the host system 12 to allow the location of the driver device 16 to be updated by the host system 12 to determine compliance with a driver's submitted itinerary. In some embodiments, drivers may manually initiate reporting of itinerary data from their driver devices 16 to the host system 12, such as by checking in with the host system 12. The current location/velocity of the driver(s) can be used by the host system 12 to identify drivers that are available to fulfill a rideshare request. In another embodiment, the application 27 may be programmed to request itinerary data of a driver from the external system 19 at a variety of instants of time during a selected time frame such as, for instance, 8:00 a.m. to 6:00 p.m. local time. The itinerary data received from the external system 19 can then be used by the host system 12 to identify the drivers that are available to fulfil a rideshare request.

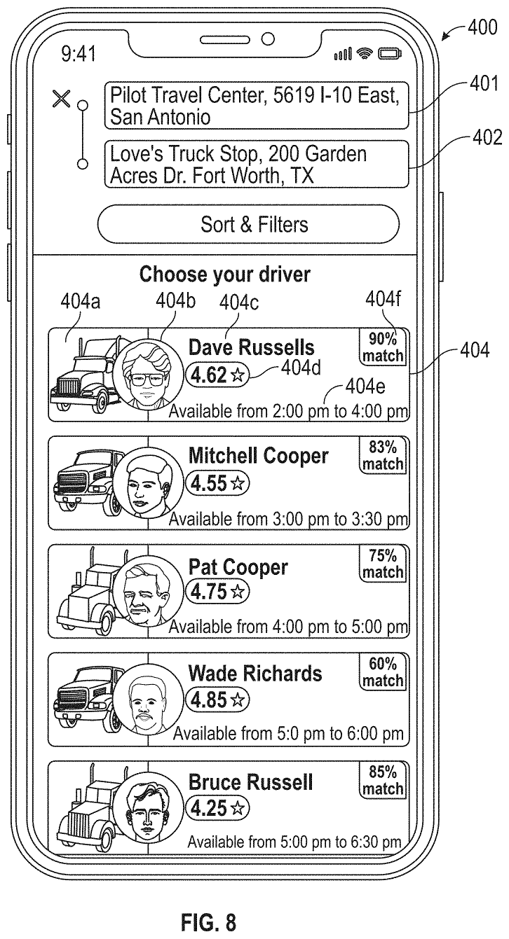

In step 104, the host system 12 sends driver profile data, including the driver itinerary data, and other information regarding the driver, such as a photograph of the driver, a photograph of the driver's truck, information regarding the driver's professional experience, information regarding the truck (e.g., class 8 vehicle), driver preferences, the driver's authority owner's name and associated motor carrier name and number, to the passenger device 14 via the network 18. The application 27 on the passenger device 14 may be programmed to display the driver profile data as selectable indicators in the form of driver profile banners on output device 20. Such an embodiment can be seen in FIG. 8, which will be described in more detail herein.

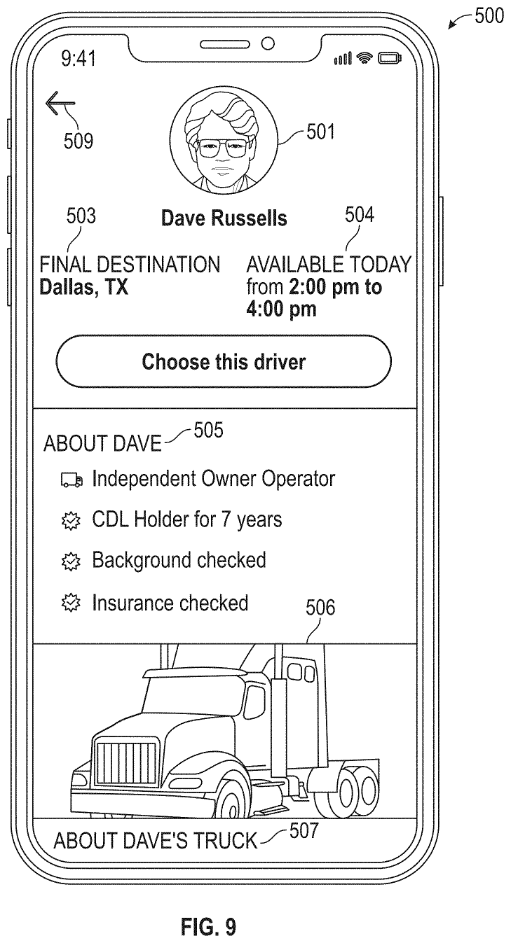

In step 106, the passenger may review a profile of drivers by clicking, touching, or otherwise selecting the selectable indicator associated with the desired driver on the output device 20, as shown in step 108. In one embodiment of the application 27, the driver profile may be displayed on a driver profile screen 500 by the output device 20 such as the one shown in FIG. 9, which will be described in more detail herein.

At a decision step 110, the application 27 may determine if the passenger has selected a driver after reviewing their profile. If the passenger has not selected a driver, the application 27 may return to step 106 to allow the user to review additional driver profiles until the passenger finds a driver the passenger would like to travel with.

At decision step 110, if the passenger has selected a driver that the passenger would like to travel with, as shown at step 110 the application 27 may be programmed to send a rideshare request to the selected driver via the communication device 25 and the network 18, as shown in step 112. For instance, the application 27 may send the passenger profile data, including identification data, passenger location data, passenger pick-up point location data and drop-off point location data via the network 18 to the host system 12, the host system 12 being programmed to send that data with the rideshare request to the driver device 16 via the network 18. The passenger location data and the passenger pick-up point location data may be different, indicating that the passenger currently is not at the passenger pick-up point location.

At decision step 114, the selected driver reviews the passenger profile data and determines whether or not to accept the rideshare request. In some embodiments, the motor carrier authority includes a privilege to the driver to be able to accept the rideshare request. In some embodiments, however, the motor carrier authority retains the right to review and approve the rideshare request before a final acceptance of the rideshare request is issued. In this instance, once the driver accepts the rideshare request (i.e., an unconfirmed rideshare request), such unconfirmed rideshare request is provided to the motor carrier authority for final acceptance. In some embodiments, the host system 12 sends a message including the unconfirmed rideshare request and the name of the driver to the motor carrier authority via the external system 19 for final acceptance. Once the rideshare request has been finally accepted, the driver is available to provide transportation services to the passenger. In operation, the driver may enter a confirmation into the driver device 16 via the input device 21 and/or the motor carrier authority may enter a confirmation into the external system 19. The application 27 may transmit a driver confirmation message from the driver device 16 to the host system 12 via the network 18.

If confirmed, a confirmation message may be presented on the passenger device 14 at a step 114. In one embodiment of the application 27, when the driver and/or the motor carrier authority accepts the proposed rideshare request, in addition to the confirmation message, the host system 12 is programmed to send real-time location updates of the driver device 16 to the passenger device 14. In such an embodiment, the application 27 is programmed to cause the device locator 23 of the driver device 16 to send real-time updates of the location of the driver device 16 to the host system 12 via the processor 24, the communication device 25 and the network 18. The host system 12 is programmed to send the driver device 16 location to the passenger device 14 via the network 18 and the communication device 25 to update the passenger as the driver travels to the pick-up point location as will be described further herein.

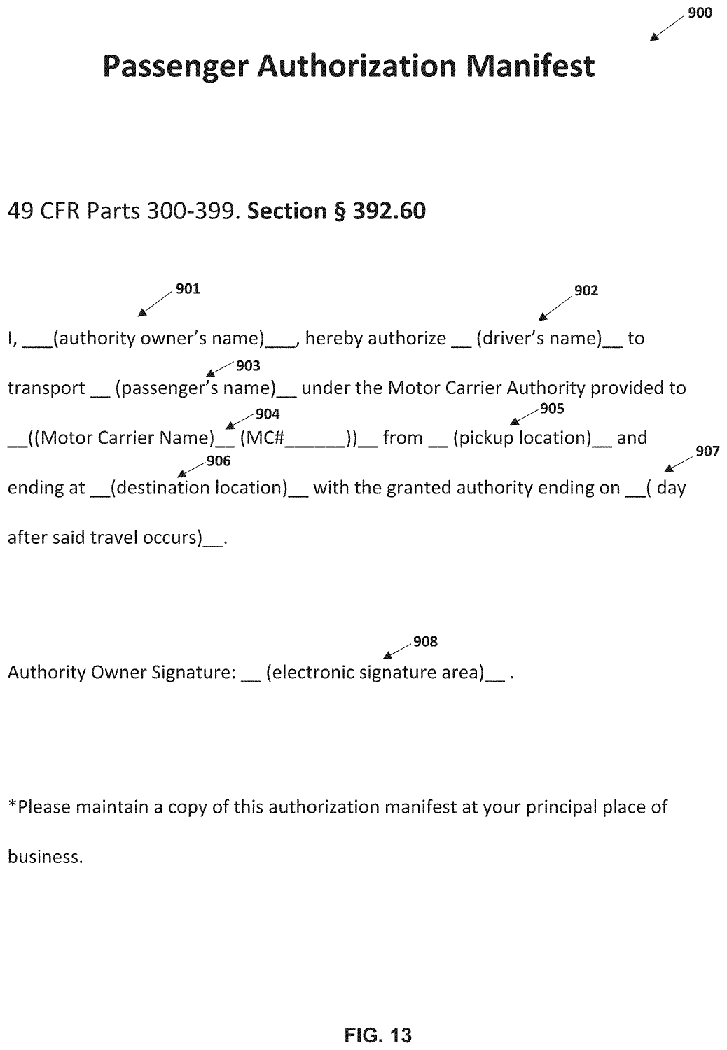

Furthermore, if confirmed, at step 116 host system 12 may generate a passenger authorization manifest to be stored at external system 19. In one embodiment of the application 27, when the driver accepts the proposed rideshare request, in addition to the confirmation message and real-time location updates, the host system 12 is programmed to generate a passenger authorization manifest 900, as shown in FIG. 13. The passenger authorization manifest 900 is provided with an authority owner's name field 901, a driver's name field 902, a passenger's name field 903, a motor carrier name and number field 904, a pick-up point location field 905, a drop-off point location field 906, a date field 907, and an electronic signature field 908. The host system 12 is programmed to update the authority owner's name field 901, the driver's name field 902, and the motor carrier name and number field 904 using the driver profile information, and the passenger's name field 903, the pick-up point location field 905, and the drop-off point location field 906 using the passenger profile information. The host system 12 is programmed to updated the electronic signature field 908 upon confirmation of a rideshare request by the driver and/or the motor carrier authority. In some embodiments, the host system 12 sends the passenger authorization manifest 900 to the external system 19 for the electronic signature 908. Upon completion of the passenger authorization manifest, the host system 12 is programmed to send the completed passenger authorization manifest to the external system 19.

If declined or the driver does not confirm within a predefined time limit, the passenger may be notified of the same by the host system 12. The passenger may then select another driver at step 108. The process may then continue from step 110 as described above.

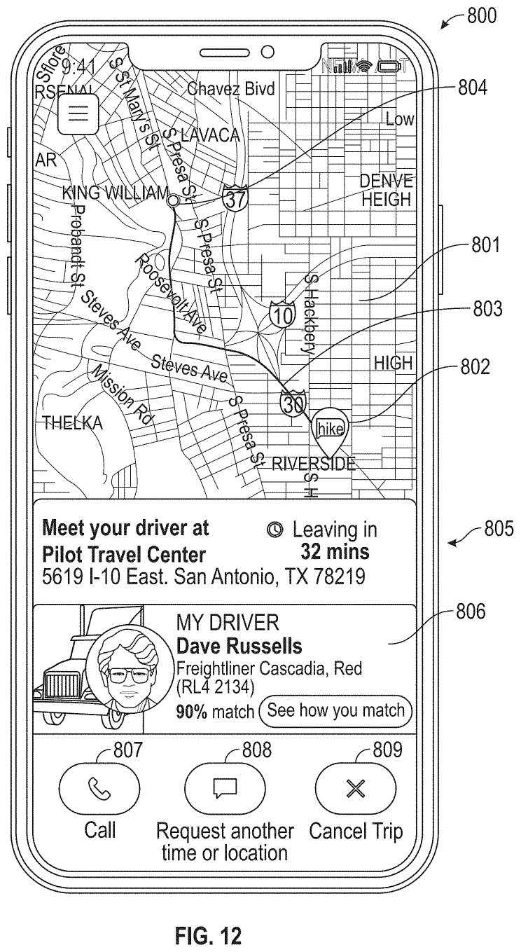

At step 118, the host system 12 begins to collect and send real-time location updates of the driver device 16 to the passenger device 14. The location updates may be displayed on the passenger device 14 as a visible ETD indicator (805 FIG. 12) such as the embodiment shown in FIG. 12. The application 27 may be programmed to calculate and display an estimated time of departure (ETD) so that the passenger is apprised, in real-time, of the time that the driver will depart from the pick-up location. The ETD can be calculated by determining a velocity of the driver device 16 and multiplying the velocity by a distance to the pick-up location plus a predetermined period of time that driver would be required to wait before departing, such as 15 minutes.

Once the driver arrives at the pick-up point location, the host system 12 and application 27 may be programmed to handle location services of the passenger device 14 and the driver device 16 in a number of ways. For instance, in one embodiment, the host system 12 may be programmed to automatically stop sending real-time ETD updates of the driver device 16 to the passenger device 14 when the host system 12 determines that the driver device 16 and the passenger device 14 are within a predetermined distance of one another for a predetermined period of time. In such an embodiment, the predetermined distance may be within a range of between 0 feet and 300 feet and the predetermined period of time may be within a range of between 5 minutes and 30 minutes. In one embodiment, the host system 12 may be programmed to stop sending real-time ETD updates to the passenger device 14 once the host system 12 determines the driver device 16 has reached the pick-up point location.

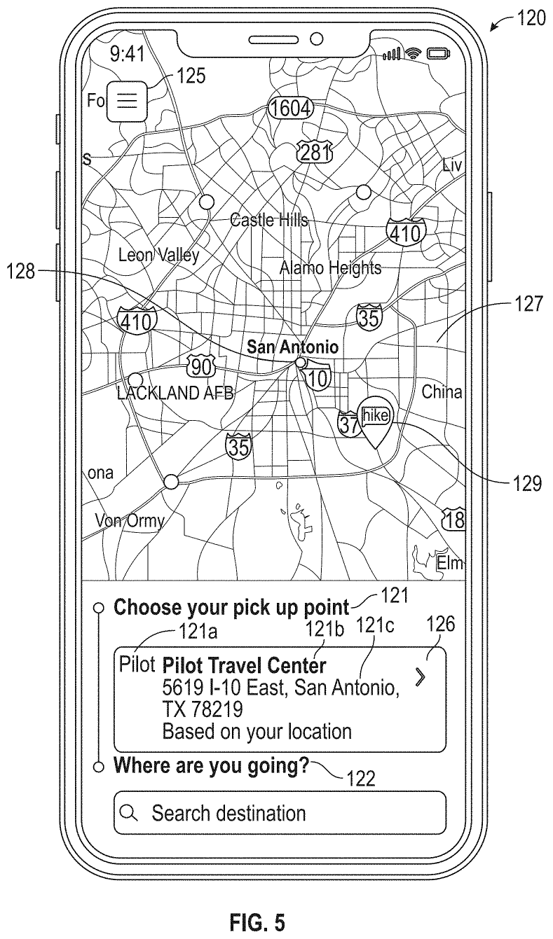

As illustrated in FIG. 5-12, the system 10 for scheduling a rideshare may include the application 27 executed by the processor 24 of the passenger device 14 that is capable of communicating with the host system 12 via the network 18. The system 10 may include a separate program, application or “app”, or a widget, each of which may correspond to instructions stored in the memory 26 of the passenger device 14 and/or the driver device 16 for execution by the processor 24 of the passenger device 14 and/or the driver device 16. Alternately, the system 10 may include instructions stored in the memory 36 of the host system 12 for execution by the processor 35 of the host system 12 with results sent via the network 18 to be displayed on the output device 20 of the passenger device 14 and the driver device 16.

The instructions of the application 27, when executed by the processor 24 of the passenger device 14 and/or the driver device 16, cause the passenger device 14 and/or the driver device 16 to perform certain tasks. For example, such tasks may include displaying content such as a home screen. The logic 34 may support both a passenger home screen 120 or a driver home screen (not shown), for example, depending on the type of user logging in to the application 27. Shown in FIG. 5 is an exemplary passenger home screen 120 of the application 27. The passenger home screen 120 may be provided with a pick-up point field 121, a drop-off point field 122, and a menu selectable indicator 125. By selecting the pick-up point field 121, or other suitably assigned or programmed selectable indicator or interactivity option (such as swiping) available on the passenger device 14, the passenger may begin a location capture process to locate pick-up locations by proximity, for instance. Each of these respective selectable indicators allows the user to access the various aspects and screens of the application 27.

The instructions of the application 27, when executed by the processor 24 of the passenger device 14, causes the application 27 to obtain the passenger device's 14 current location using the device locator 23. The application 27 is programmed to send a signal indicating the current location of the passenger device 14 to the host system 12 via the network 18. Upon receipt of the signal indicating the current location of the passenger device 14, the host system 12 may be programmed to match the current location with a pick-up point location which may be stored, for instance in the database 32 on the host system 12. In some embodiments of the system 10, the list of pick-up point locations may include pre-authorized locations, e.g., truck stops. Once the host system 12 has located a pick-up point location within a predefined distance of the current location of the passenger device 14, the host system 12 is programmed to send the pick-up point location information to the passenger device 14 via the network 18.

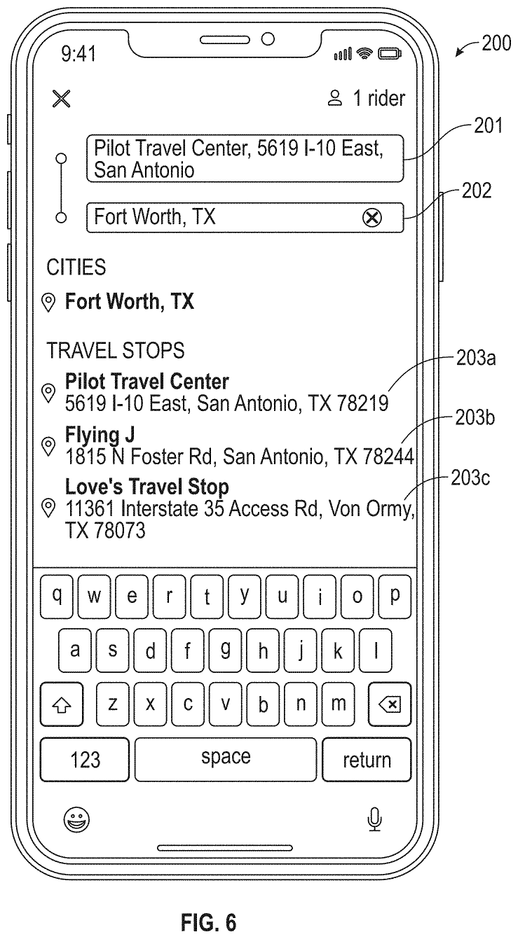

Upon receiving the pick-up point location information, the application 27 on the passenger device 14 is programmed to display the pick-up point location information on the pick-up point field 121, for instance as shown in FIG. 5. The pick-up point field 121 may be provided with at least one graphic of the logo of the pick-up point location 121a, a name field 121b, and an address field 121c. A visual indicator of the passenger's current location is provided on map 127 as indicated by marker 128. A visual indicator of the location contained in pick-up point field 121 may be indicated by marker 129. If the passenger wishes to see information about a different pick-up location, the passenger may select appropriately programmed selectable indicators such as a right arrow selectable indicator 126. This will allow the passenger to navigate to different pick-up points that the host system 12 has stored in the database 32, for instance. Selecting the right arrow selectable indicator 126, for instance, causes application 27 to send a signal to the host system 12 indicating that the passenger would like to see other pick-up point locations. In response to receiving the signal, the host system 12 may be programmed to send the passenger to a location selection screen 200, as shown in FIG. 6. Once on the location selection screen 200, the passenger can select the location screen pick-up point field 201 and manually enter information about their preferred pick-up point location using the input device 21 such as a physical address, cross-streets, a city, a zip code, or other information which will allow the host system 12 to locate the pick-up location data. On the other hand, if the passenger likes the pick-up point location selected by the host system 12 based on the current location of the passenger device 14, the passenger can continue to complete a rideshare request by clicking or otherwise selecting the drop-off point field 202.

The passenger may select a drop-off point location by manually entering information about their preferred drop-off point location into the drop-off point field 202 using the input device 21, such as by entering a physical address, cross-streets, a city, a zip-code, or other information which will allow the host system 12 to locate the drop-off point data. The host system 12 may be programmed to match the preferred drop-off point location information with a drop-off point location which may be stored, for instance in the database 32 on the host system 12. In some embodiments of the system 10, the list of drop-off point locations may include pre-authorized locations, e.g., truck stops. Once the host system 12 has located a list of drop-off point locations matching the passenger's preferred drop-off point location information, the host system 12 is programmed to send the drop-off point location information to the passenger device 14 via the network 18. The list of drop-off point location information is displayed on the passenger device 14 as selectable travel stop indicators 203a-c.

When the passenger clicks or otherwise selects a selectable travel stop indicator 203a-c, the application 27 may be programmed to send information to the host system 12 via the network 18. For instance, the application 27 may send the location contained in the pick-up point location field 201 and the drop-off point location selected by the passenger by clicking on or otherwise selecting a travel stop indicator 204a-c.

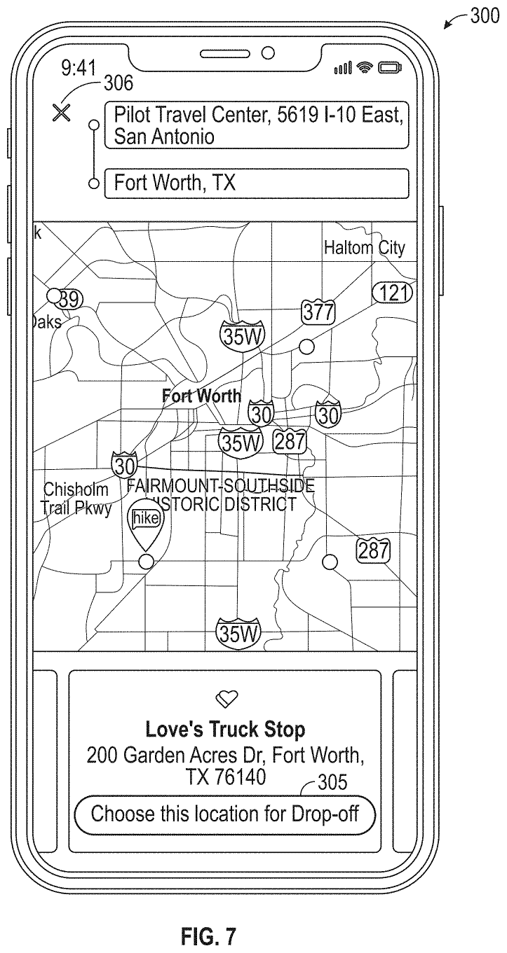

Upon receipt of the pick-up point location and drop-off point location, the host system 12 may be programmed to send the passenger to a drop-off point selection screen 300, as shown in FIG. 7. Once on the drop-off point selection screen 300, the passenger can confirm the drop-off point location selected on the previous location selection screen 200 by clicking or otherwise selecting a choose this location selectable indicator 305. On the other hand, if the passenger would like to select another drop-off point location, the passenger can return to the location selection screen 200 by clicking or otherwise selecting the cancel selectable indicator 306. Selection of the cancel selectable indicator 306 will cause the application 27 to return to the location selection screen 200 where the passenger may select another drop-off point location as described above

Upon confirmation of a drop-off point location, the host system 12 may be programmed to send the passenger to a driver selection screen 400, as shown in FIG. 8. The host system 12 may be programmed to locate drivers who are currently active and scheduled to make a stop at the location contained in pick-up point location field 401 and drop-off point location field 402. In one embodiment, the host system 12 may be programmed to locate drivers who are currently active by pinging, or otherwise sending a connection signal to the driver devices 16 that reported being scheduled to make a stop at the location (or pass within a predetermined distance to the location) contained in the pick-up point location field 401 to determine that the drivers devices 16 are still active and able to respond to the host system 12. If, for instance, a driver device 16 is not able to respond to the ping sent by the host system 12, the host system 12 will not list that driver device 16 as currently active. Even if a driver is not scheduled to make a stop at the location contained in pick-up point location field 401, the host system 12 may still list a driver device 16 as currently active if the driver device 16 is within a predetermined distance (e.g., 100 miles) from the location contained in the pick-up point location field 401. In one embodiment, the host system 12 may be programmed to locate drivers who are within a predetermined distance from the location contained in the pick-up point location field 401 by pinging, or otherwise sending a connection signal to the driver device 16. Likewise, if the driver device 16 is determined to be outside the predetermined distance from the location contained in the pick-up point location field 401, the host system 12 will not list that driver device 16 as currently active. For example, once a driver gets within 100 miles of a region they may be travelling through with no plans of stopping, the host system 12 may list the driver as currently active to pick up a passenger. In this instance, the host system 12 may place the driver on the passengers “available driver list.” If the driver is selected by a passenger, then the driver may be able to pick up the passenger despite having no initial plans to make a stop in a specific region.

Software for matching geo-locations of pick-up point locations relative to a driver's location are available commercially by companies such as RideShark™, RidePro™, and RideAmigos™. Such software may be used to match geo-locations of pick-up point locations and/or drop off point locations relative to a driver's current location or expected location. The driver's route can be modeled as a series of geo-locations, which may be time-based indicating an expected location of the driver at particular instances of time. The driver's expected location at a particular instance of time may be entered into the software as the driver's actual location to assist in matching particular drivers with particular passengers.

The host system 12 will then determine whether, of the currently active drivers scheduled to pass within a first predetermined distance, or make a stop at the location contained in pick-up point location field 401, whether such drivers are also scheduled to make a stop at, or pass within a second predetermined distance of, the location contained in drop-off point location field 402. Only currently active drivers scheduled to make a stop at or pass within the first and second predetermined distances of both locations will be displayed on the passenger device 14.

Once the host system 12 has determined a list of driver devices 16 that are currently active and able to respond to the host system 12 and scheduled to be able to stop at both the location contained in pick-up point location field 401 and drop-off point location field 402, the host system 12 is programmed to send the list of driver devices 16 to the passenger device 14 where the application 27 is programmed to display the list of available drivers. The list of available drivers may be visually displayed on a driver selection screen 400 provided with a selectable indicator, such as a driver banner 404, which may include a picture of the vehicle 404a, a picture of the driver 404b, driver name 404c, driver rating 404d, driver availability 404e, and preference match score 404f, as shown in FIG. 8.

The application 27 is programmed to provide the passenger with information about the available drivers to aid in the passenger's selection of a driver for the passenger's intended ride share. In one embodiment, the passenger may get additional information about the available driver by clicking or otherwise selecting one of the driver banners 404 associated with an available driver. Selection of a driver banner 404 causes the application 27 to display a driver profile screen 500, as shown in FIG. 9. It should be noted that the driver profile screen 500 may be a new screen in the application 27. The driver profile screen 500 may be provided with a picture of the driver 501, a final destination section 503, an availability section 504, a description of the drivers' professional experience in a driver information section 505, a picture of the vehicle 506, a description of the vehicle the driver is operating in a vehicle information section 507, a choose this driver selectable indicator 508, and a back selectable indicator 509.

After reviewing the driver information on the driver profile screen 500, the passenger may indicate a desire to review information about another driver on the list of drivers by clicking or otherwise selecting the back selectable indicator 509. Selection of the back selectable indicator 509 will cause the application 27 to return to the driver selection screen 400 where the passenger may visually select another driver as described above.

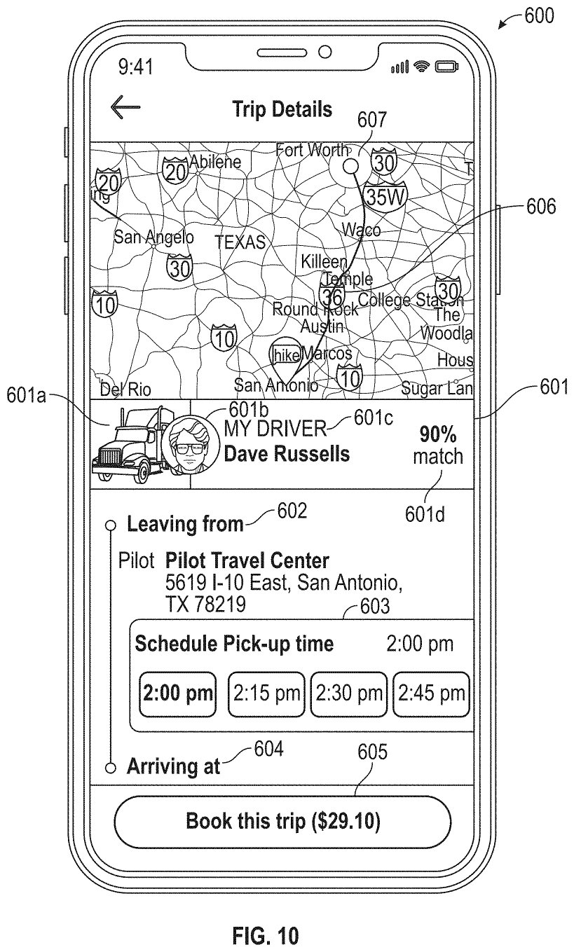

Alternatively, the passenger may indicate a desire to travel with the driver by clicking or otherwise selecting the choose this driver selectable indicator 508. Selection of the choose this driver selectable indicator 508 causes the application 27 to send a signal to the host system 12 indicating the passenger's request to have the selected driver fulfill the rideshare request. Selection of the choose this driver selectable indicator 508 causes the application 27 to display a passenger scheduling screen 600, as shown in FIG. 10. It should be noted that the passenger scheduling screen 600 may be a new screen in the application 27. The passenger scheduling screen 600 may be provided with a selectable indicator, such as a driver selection banner 601, a leaving from section 602, a scheduling section 603, an arriving at section 604, a book this trip selectable indicator 605, and a back selectable indicator 606. The scheduling section 603 provides the passenger the ability to select a departure time from a plurality of departure times that may vary by a predetermined increment, such as every 15 minutes. The book this trip selectable indicator 605 may provide the passenger with the price associated with the requested rideshare. The passenger may indicate at what time the passenger would like to depart from the location contained in the leaving from section 602 by selecting an available time from the scheduling section 603. Selection of a time in the scheduling section 603 causes the application 27 to send a signal to the host system 12 indicating the passenger's request to depart from the location contained in the leaving from section 602 at the time contained in the scheduling section 603.

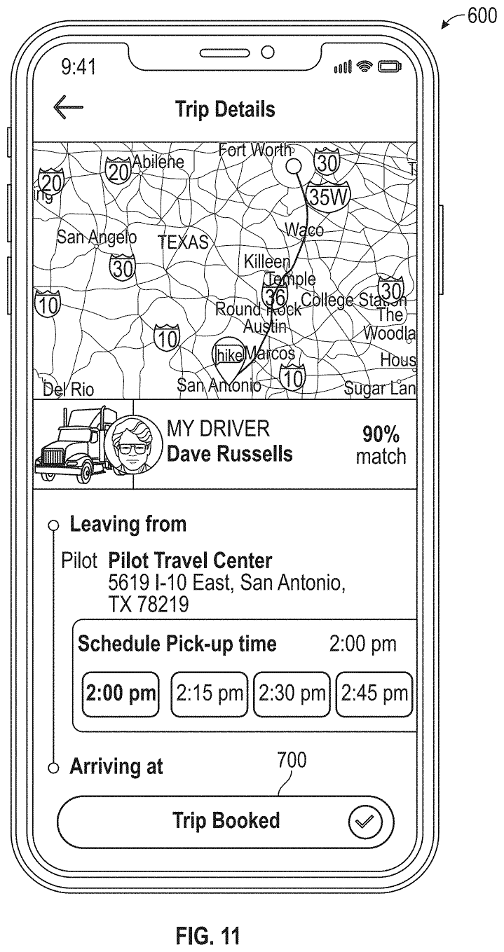

After reviewing the information on the passenger scheduling screen 600, the passenger may indicate a desire to request a rideshare by clicking or otherwise selecting the book this trip selectable indicator 605. Selection of the book this trip selectable indicator 605 will cause the application 27 to send a signal to the host system 12 indicating the passenger's confirmation of a rideshare request. Selection of the book this trip selectable indicator 605 causes the application 27 to display a trip booked confirmation icon 700 on the passenger scheduling screen 600, as shown in FIG. 11. It should be noted that the trip booked confirmation icon 700 may be displayed as a pop-up screen as is known in the art.

The selection of the book this trip selectable indicator 605 on the passenger scheduling screen 600 will cause the application 27 to send a signal to the host system 12 indicating the passenger is seeking confirmation from the driver. The host system 12 will send a signal to the driver device 16 seeking acceptance of the rideshare request.

The driver may indicate acceptance of rideshare request by clicking or otherwise selecting an accept selectable indicator. The driver may deny the request by clicking or otherwise selecting a decline selectable indicator (not shown). When the driver clicks the accept selectable indicator (not shown), the application 27 is programmed to send a signal via the network 18 to the host system 12 indicating acceptance of the rideshare request.

Upon receiving the signal indicating acceptance of the rideshare request, the host system 12 is programmed to send a signal via the network 18 to the passenger device 14 indicating that the rideshare request has been accepted. At this point, the host system 12 may process payment from the passenger for the requested rideshare. This can be accomplished by way of a credit card, or debit card payment, for example. Information regarding the passenger's credit or debit card can be stored on the host system 12 and used to process and pay for the passenger's rideshare.

The host system 12 may also be programmed to automatically indicate that the driver who accepted the request for showing is no longer available, and thus, would not show on a list of available drivers when another passenger requests a rideshare. In such an embodiment, the host system 12 may be programmed to send a signal via the network 18 to the driver device 16 indicating the status of not available. Information with respect to available/unavailable drivers can be stored in the database 32.

Upon receiving the signal indicating that the request for showing has been accepted, the application 27 on the passenger device 14 may be programmed to display a rideshare tracking screen 800, as shown in FIG. 12. In the embodiment shown in FIG. 12, the rideshare tracking screen 800 is provided with a map 801, a visual indicator of the pick-up point location indicated by marker 802, a line 803 or other visual indicator showing the path the driver will travel to arrive at the drop-off point location, a location marker 804 or other visual indicator of the real-time location of the driver device 16, an ETD section 805 or other visual indication of the estimated time of departure of the driver, a driver banner 806, a call selectable indicator 807 to contact the driver, a schedule change selectable indicator 808 to request another time of departure or pick-up point and/or drop-off point location, and a cancel trip selectable indicator 809.

After indicating acceptance of the rideshare request, the application 27 on the driver device 16 may be programmed to automatically cause the processor 24 to read the device locator 23 of the driver device 16 and send a signal indicating real-time updates of the location of the driver device 16 via the communication device 25 to the host system 12 via the network 18. Upon receipt of the signal, the host system 12 may be programmed to send a signal indicating the driver device 16 location to the passenger device 14 to update the passenger as the driver travels to the pick-up point location, the application 27 on the passenger device 14 being programmed to display the current estimated time of departure of the driver as an ETD section 805 on the rideshare tracking screen 800.

In one embodiment of the application 27, a current rideshare screen (not shown) may be shown on the passenger device 14 when the host system 12 determines that the passenger device 14 and the driver device 16 are within a predetermined distance of one another for a predetermined period of time. In one embodiment, the current rideshare screen is provided with a map (127, FIG. 5), a first visual marker of the pick-up point location (129, FIG. 5), a line or other visual indicator showing the path the driver will travel to arrive at the drop-off point location (606, FIG. 10), a second visual marker (607, FIG. 10) or other visual indicator of drop-off point location, a location marker (not shown) or other visual indicator of the current position of the passenger device 14, and an ETA section (not shown) or other visual indication of the estimated time of arrival of the passenger at the drop-off point location.

The host system 12 may be programmed to ping or otherwise contact the passenger device 14 constantly or at predetermined intervals to update the location of the passenger device 14. Upon receipt of the current location of the passenger device 14, the host system 12 may be programmed to update the database 32 to indicate the current location of the passenger device 14. In this way, the host system 12 may keep track of the driver during the rideshare trip and update the current rideshare screen.

The host system 12 may be programmed to continually update the location of the passenger device 14 until a triggering event happens. For instance, a triggering event may include, but is not limited to, the passenger device 14 sending a signal to the host system 12 via the network 18 indicating the passenger has arrived at the drop-off point location. The application 27 will stop sending the current location of the passenger device 14 and the host system 12 may be programmed to automatically make the status of the driver available once a triggering event occurs. In this way, the driver will be available to accept future rideshare requests.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A system, comprising:
a computer system having one or more processor, and one or more non-transitory computer readable medium, the one or more processor executing computer executable instructions to cause the one or more processor to:
receive trip itineraries from a plurality of driver devices, each of the trip itineraries specifying a driver, at least one pick-up region along a route to a final destination, and a driver time associated with each pick-up region, each driver being associated with stored driver data identifying a driver name, an authority owner name, a motor carrier name, and a motor carrier number;
receive a rideshare request from at least one passenger device, the rideshare request identifying a passenger, and having a pickup location, a drop-off location, and a pick-up time, the passenger device being associated with stored passenger data identifying a passenger name;
match the rideshare request with at least one trip itinerary;
generate a passenger manifest identifying passenger name, selected driver name, pick-up location, drop-off location, a date of travel, a motor carrier name, and motor carrier number, and a signature of an authority owner;
book a ridesharing trip including the passenger with the selected driver;
provide the driver device with the rideshare request based on the driver selection;
provide a rideshare request confirmation to the passenger device; and
store the passenger manifest on the non-transitory computer readable medium.

2. The system of claim 1, wherein the stored driver information further identifies driver responses to a first predetermined set of questions indicative of driver preference.

3. The system of claim 1, wherein the stored passenger information further identifies passenger responses to a second predetermined set of questions indicative of passenger preference.

4. The system of claim 1, wherein the at least one pick-up region is a county, city, village, township, district, or other administrative division.

5. The system of claim 1, wherein the at least one pick-up region contains a plurality of pick-up locations, and wherein the computer executable instructions cause the processor to display at least one selectable indicator indicative of the pick-up locations and receive selection of at least one selectable indicator indicating selection of one of the pick-up locations.

6. The system of claim 5, wherein the at least one pick-up region further contains a plurality of drop-off locations.

7. The system of claim 1, wherein the pick-up time is within the driver time associated with each pick-up region.

8. The system of claim 1, wherein the signature of an authority owner is an electronic signature.

9. A method, comprising:
receiving trip itineraries from a plurality of driver devices, each of the trip itineraries specifying a driver, at least one pick-up region along a route to a final destination, and a driver time associated with each pick-up region, each driver being associated with stored driver data identifying a driver name, an authority owner name, a motor carrier name, and a motor carrier number;
receiving a rideshare request from at least one passenger device, the rideshare request identifying a passenger, and having a pickup location, a drop-off location, and a pick-up time, the passenger device being associated with stored passenger data identifying a passenger name;
matching the rideshare request with at least one trip itinerary;
generating a passenger manifest identifying passenger name, selected driver name, pick-up location, drop-off location, a date of travel, a motor carrier name, and motor carrier number, and a signature of an authority owner;
booking a ridesharing trip including the passenger with the selected driver;
providing the driver with the rideshare request based on the driver selection;
providing a rideshare request confirmation to the passenger; and
storing the passenger manifest on the non-transitory computer readable medium.

10. The method of claim 9, wherein the stored driver information further identifies driver responses to a first predetermined set of questions indicative of driver preference.

11. The method of claim 9, wherein the stored passenger information further identifies passenger responses to a second predetermined set of questions indicative of passenger preference.

12. The method of claim 9, wherein the at least one pick-up region is a county, city, village, township, district, or other administrative division.

13. The method of claim 9, wherein the at least one pick-up region contains a plurality of pick-up locations.

14. The method of claim 13, wherein the at least one pick-up region further contains a plurality of drop-off locations.

15. The method of claim 9, wherein the pick-up time is within the driver time associated with each pick-up region.

16. The method of claim 9, wherein the signature of an authority owner is an electronic signature.
